(19) United States
(12) Patent Application Publication
(10) Pub. No.: US 2021/0334304 A1
(43) Pub. Date: Oct. 28, 2021

(54) DISASTER INFORMATION PROVIDING APPARATUS AND METHOD

(71) Applicant: The Republic of Korea(Ministry Interior), Seoul (KR)

(72) Inventors: Kyung Soo Pyo, Sejong-si (KR); Ji Hye Jeong, Dong-gu (KR); Woo Suk Hwang, Jung-gu (KR); Jong Hoon Lee, Nam-gu (KR); Yoo Jung Kim, Jung-gu (KR); Tae Ho Jung, Jung-gu (KR); Sek Chin Chang, Jungnang-gu (KR); Seong Jong Choi, Dongjak-gu (KR); Hyun Ji Lee, Guro-gu (KR); Yoon Kwan Byun, Eunpyeong-gu (KR)

(21) Appl. No.: 16/932,407

(22) Filed: Jul. 17, 2020

(30) Foreign Application Priority Data
Apr. 23, 2020 (KR) 10-2020-0049490

(51) Int. Cl. G06F 16/538; G06F 16/535; G06F 40/284; H04W 4/90

(52) U.S. Cl. CPC G06F 16/538; H04W 4/90; G06F 40/284; G06F 16/535

(57) ABSTRACT

A disaster information providing apparatus includes a memory that stores words and images corresponding to each other, a communication interface configured to receive a notification message, a processor configured to determine whether the notification message includes a predetermined word, and when the notification message includes the predetermined word, extract a predetermined image corresponding to the predetermined word from the memory, and a display that displays the predetermined image.

### CROSS-REFERENCE TO RELATED APPLICATION

This application claims the benefit of Korean Patent Application No. 10-2020-0049490, filed on Apr. 23, 2020, in the Korean Intellectual Property Office, the disclosure of which is incorporated herein in its entirety by reference.

### BACKGROUND

### 1. Field

Embodiments of the disclosure relate to a disaster information providing apparatus and method, which may provide more intuitive disaster information.

### 2. Description of the Related Art

In the event of a natural disaster such as an earthquake or landslide, or a disaster such as an explosion or epidemic, damage caused by the disaster may be reduced by providing disaster information.

While a method of providing disaster information through disaster broadcast enables simultaneous reception of the information, there is a limit in that only users who access the medium may receive the information.

To overcome this limit, a method of providing disaster information by transmitting a text message to terminal users through mobile communication may be used.

As the text message including the disaster information is transmitted in the form of broadcast, it is not suitable for transmitting large-capacity multimedia information such as an image, and thus, the text message is generally made of characters implemented in the language of a corresponding country.

However, users who do not understand the language of the country or users who have foreign terminals that do not support the Korean encoding method may not recognize disaster information even when a text message including the disaster information is displayed on a screen of the terminal.

Accordingly, in order to accurately and quickly provide disaster information included in a text message to users having a language barrier, it is necessary to display disaster information more intuitively.

### SUMMARY

Embodiments of the disclosure provide a disaster information providing apparatus and method, which may provide more intuitive disaster information.

Additional aspects will be set forth in part in the description which follows and, in part, will be apparent from the description, or may be learned by practice of the presented embodiments of the disclosure.

According to an embodiment of the disclosure, a disaster information providing apparatus includes a memory that stores words and images corresponding to each other, a communication interface configured to receive a notification message, a processor configured to determine whether the notification message may include a predetermined word, and when the notification message may include the predetermined word, extract a predetermined image corresponding to the predetermined word from the memory, and a display that displays the predetermined image.

In an embodiment, each of the words may include a language meaning a disaster type or action guidelines, each of the images may include a non-language means indicating a disaster type or action guidelines, and each of the images may be a still image or a video.

In an embodiment, the processor may be further configured to determine whether the notification message may include a predetermined special character, extract a word indicated by the predetermined special character from the notification message when the notification message may include the predetermined special character, determine whether the extracted word is a word stored in the memory, and determine that the notification message may include the predetermined word when the extracted word is a word stored in the memory.

In an embodiment, to extract a word indicated by the predetermined special character from the notification message, the processor may be further configured to extract a word between a first special character indicating a start and a second special character indicating an end.

In an embodiment, the notification message may be received through a system information block (SIB).

In an embodiment, the notification message may include an emergency disaster text message, an urgent disaster text message, and a safety guide text message.

In an embodiment, to extract a word indicated by the predetermined special character from the notification message, the processor may extract a word after the predetermined special character or a word before the predetermined special character.

In an embodiment, the memory may store titles and colors corresponding to each other, and the processor may extract a predetermined title of the notification message, extract a predetermined color corresponding to the predetermined title from the memory, and apply the predetermined color to at least a part of the predetermined image.

In an embodiment, the titles may vary depending on an emergency level of a disaster.

According to an embodiment of the disclosure, a disaster information providing method includes storing, by a memory, words and images corresponding to each other, receiving, by a communication interface, a notification message, determining, by a processor, whether the notification message may include predetermined a word, when the notification message may include the predetermined word, extracting a predetermined image corresponding to the predetermined word from the memory, and displaying, by a display, the image.

In an embodiment, each of the words may include a language meaning a disaster type or action guidelines, each of the images may include a non-language means indicating a disaster type or action guidelines, and each of the images may be a still image or a video.

In an embodiment, the notification message may be received through a system information block (SIB).

In an embodiment, the notification message may include an emergency disaster text message, an urgent disaster text message, and a safety guide text message.

In an embodiment, the determining of whether the notification message includes the predetermined word may include determining whether the notification message includes a predetermined special character, extracting a word indicated by the predetermined special character from the notification message when the notification message includes the predetermined special character, determining whether the extracted word is a word stored in the memory, and determining that the notification message includes the predetermined word when the extracted word is the word stored in the memory.

In an embodiment, the extracting of the word indicated by the predetermined special character from the notification message may include extracting a word between the first and second special characters included in the predetermined special character, the first special character may mean a special character indicating a start, and the second special character may mean a special character indicating an end.

In an embodiment, the extracting of the word indicated by the predetermined special character from the notification message may include extracting a word after the predetermined special character or a word before the predetermined special character.

In an embodiment, the disaster information providing method may further include storing, by the memory, the titles and colors corresponding to each other, extracting, by the processor, a predetermined title of the notification message, extracting, by the processor, a predetermined color corresponding to the predetermined title from the memory, and applying, by the processor, the predetermined color to at least a part of the predetermined image.

In an embodiment, the titles may vary depending on the emergency level of a disaster.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a disaster information providing system according to an embodiment of the disclosure;

FIG. 2 is a block diagram of a configuration of a disaster information providing apparatus according to an embodiment of the disclosure;

FIG. 3 is a flowchart of a disaster information providing method according to an embodiment of the disclosure.

FIGS. 4 and 5 are flowcharts of a method of determining the inclusion of a predetermined word, according to an embodiment of the disclosure.

FIG. 6 is a flowchart of a disaster information providing method according to an embodiment of the disclosure.

FIG. 7 illustrates integrated public alert and warning system (IPAWS) symbols applicable to an embodiment of the disclosure.

### DETAILED DESCRIPTION

Reference will now be made in detail to embodiments, examples of which are illustrated in the accompanying drawings, wherein like reference numerals refer to like elements throughout. In this regard, the embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the disclosure allows for various changes and numerous embodiments, embodiments will be illustrated in the drawings and described in detail in the written description. However, this is not intended to limit the disclosure to particular modes of practice, and it is to be appreciated that all changes, equivalents, and substitutes that do not depart from the spirit and technical scope of the disclosure are encompassed in the disclosure. In the description of the disclosure, certain detailed explanations of the related art are omitted when it is deemed that they may unnecessarily obscure the essence of the disclosure.

While such terms as “first,” “second,” etc., may be used to describe various components, such components must not be limited to the above terms. The above terms are used only to distinguish one component from another.

The terms used in the specification are merely used to describe embodiments, and are not intended to limit the disclosure. An expression used in the singular encompasses the expression of the plural, unless it has a clearly different meaning in the context. In the specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The disclosure may be described in terms of functional block components and various processing steps. Such functional blocks may be realized by any number of hardware and/or software components configured to perform the specified functions. For example, the disclosure may employ various integrated circuit (IC) components, e.g., memory elements, processing elements, logic elements, look-up tables, and the like, which may carry out a variety of functions under the control of one or more microprocessors or other control devices. Similarly, where the elements of the disclosure are implemented using software programming or software elements, the disclosure may be implemented with any programming or scripting language such as C, C++, Java, assembler language, or the like, with the various algorithms being implemented with any combination of data structures, objects, processes, routines or other programming elements. Functional aspects may be implemented in algorithms that are executed on one or more processors. Furthermore, the disclosure could employ any number of conventional techniques for electronics configuration, signal processing and/or control, data processing and the like. The words “mechanism,” “element,” “means,” and “configuration” are used broadly and are not limited to mechanical or physical embodiments, but can include software routines in conjunction with processors, etc.

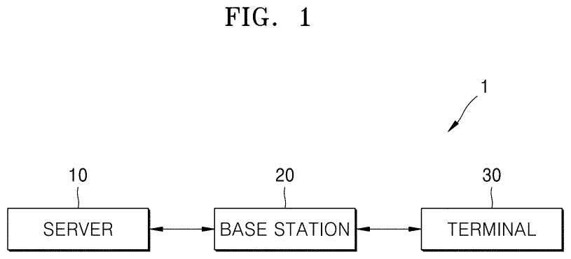

FIG. 1 is a block diagram of a disaster information providing system 1 according to an embodiment of the disclosure.

Referring to FIG. 1, the disaster information providing system 1 according to an embodiment of the disclosure may include a server 10, a base station 20, and a terminal 30.

The server 10 may include a cell broadcasting service (CBS) server that provides disaster information through a text message.

The CBS server may transmit a text message including disaster information in the form of broadcast to the terminal 30 via the base station 20. In other words, the CBS server may simultaneously transmit a broadcast message to national or local mobile communication subscribers. Accordingly, according to embodiments, disaster information may be more quickly and efficiently provided to a large number of people.

The base station 20 may simultaneously transmit a text message transmitted from the server 10 to multiple terminals as the terminal 30.

The terminal 30 may include a mobile communication subscription terminal. The terminal 30 may display, on a screen, the text message transmitted from the server 10 via the base station 20.

The terminal 30 may display, on the screen, a letter included in a text message, or an image indicated by the letter included in a text message.

The terminal 30 may display, on the screen, a title for identifying a text message, or display, on the screen, a letter and/or an image of a text message that is changed to a color indicated by the title for identifying the text message.

The text message may be classified into an emergency disaster text message, an urgent disaster text message, and a safety guide text message depending on the emergency level of disasters.

The terminal 30 may more accurately and quickly provide disaster information to users who do not understand a specific language, by extracting a predetermined word in the specific language from a text message and providing a predetermined image indicating the predetermined word on the screen.

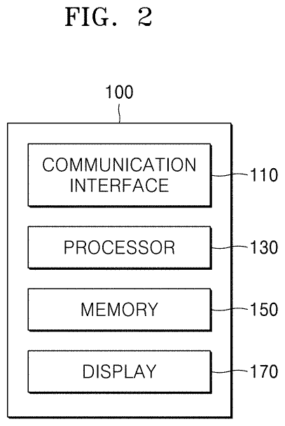

FIG. 2 is a block diagram of a disaster information providing apparatus 100 according to an embodiment of the disclosure.

Referring to FIG. 2, the disaster information providing apparatus 100 according to an embodiment of the disclosure may include a communication interface 110, a processor 130, a memory 150, and a display 170.

The communication interface 110 may receive a notification message.

The notification message may be transmitted from, for example, the CBS server, but the disclosure is not limited thereto.

The notification message may be received through a system information block (SIB), but the disclosure is not limited thereto. The SIB corresponds to a block having a relatively small size and is suitable for transmitting control information having a small capacity. In this case, the notification message may include a letter, a number, and a special character.

The notification message may include an emergency disaster text message, an urgent disaster text message, and a safety guide text message. The emergency disaster text message, the urgent disaster text message, and the safety guide text message may be classified according to the emergency level of a disaster.

The emergency disaster text message may include information about a disaster having the highest level of emergency. For example, the emergency disaster text message may include information about a disaster that needs immediate evacuation.

The urgent disaster text message may include information about a disaster having the highest level of emergency following the level of emergency of the emergency disaster text message. For example, the emergency disaster text message may include information about a disaster that needs a response.

The safety guide text message may include information about a disaster having the highest level of emergency following the level of emergency of the urgent disaster text message. For example, the safety guide text message may include information about a disaster that needs attention or prevention.

The processor 130 determines whether a notification message includes a predetermined word, and when the notification message includes the predetermined word, extracts a predetermined image corresponding to the predetermined word from the memory 150.

The predetermined word may be a linguistic expression, and the predetermined image may be a non-linguistic expression. In other words, the predetermined word may include a letter expressed by a predetermined language, and the predetermined image may include a medium that expresses information indicated by the predetermined word in a method other than the method using a letter.

The processor 130 may determine whether a notification message includes a predetermined special character, and when the notification message includes the predetermined special character, extract a word indicated by the predetermined special character from the notification message, determine whether the extracted word is the word stored in the memory 150, and when the extracted word is the word stored in the memory 150, determine that the notification message includes the predetermined word.

The predetermined special character may include one or more special characters.

The predetermined special character may include, for example, one special character. The one special character may indicate a word before the one special character or a word after the one special character.

The predetermined special character may include, for example, a plurality of special characters sequentially arranged. The sequentially arranged special characters may indicate a word before the special characters or a word after the special characters.

In this case, to extract a word indicated by the predetermined special character from a notification message, the processor 130 may extract a word after the predetermined special character or a word before the predetermined special character.

The predetermined special character may include, for example, at least one first special character indicating a start and at least one second special character indicating an end. The first special character and the second special character may indicate a work therebetween.

In this case, to extract a word indicated by the predetermined special character from a notification message, the processor 130 may extract a word between the first special character indicating a start and the second special character indicating an end.

The processor 130 may extract a predetermined title of a notification message, a predetermined color corresponding to the predetermined title from the memory 150, and apply the predetermined color to at least a part of the predetermined image.

For example, the processor 130 may extract an “emergency disaster text” that is the title of a notification message, extract a red color corresponding to the “emergency disaster text” from the memory 150, and apply the red color to the background or borders of a predetermined image,

The memory 150 stores words and images corresponding to each other.

Each of the words may include a language meaning a disaster type or action guidelines.

Each of the images may include a non-language means indicating a disaster type or action guidelines. For example, each of the images may include a still image or a video.

The memory 150 may store titles and colors corresponding to each other.

The titles and colors may vary depending on the emergency level of a disaster. For example, the titles may include an emergency disaster text, an urgent disaster text, and a safety guide text, and the colors may include red, orange, and blue, but the disclosure is not limited thereto.

The display 170 may display a predetermined image.

The display 170 may display a notification message and a predetermined image, The display 170 may display a notification message and a predetermined image on one screen or separately on different screens, but the disclosure is not limited thereto.

The display 170 may display at least a part of each of the notification message and the predetermined image in a predetermined color. The display 170 may display at least a part of each of the notification message and the predetermined image in a predetermined color, or at least a part of the predetermined image in a predetermined color, but the disclosure is not limited thereto.

According to embodiments, the disaster information providing apparatus 100, even when a notification message implemented in a specific language is transmitted, may provide users with information included in the notification message in a more intuitive method other than the specific language, thereby further guaranteeing user safety in an urgent situation.

Referring to FIGS. 1 and 2, the disaster information providing apparatus 100 may be implemented by the terminal 30.

The disaster information providing apparatus 100 may not be necessarily implemented by any one physical device, and may be implemented as a plurality of physical devices are organically combined with each other. In other words, some of elements included in the disaster information providing apparatus 100 may be implemented or installed in any one physical device, and the other elements may be implemented or installed in a different physical device. In this case, the different physical device may be implemented in a part of the terminal 30.

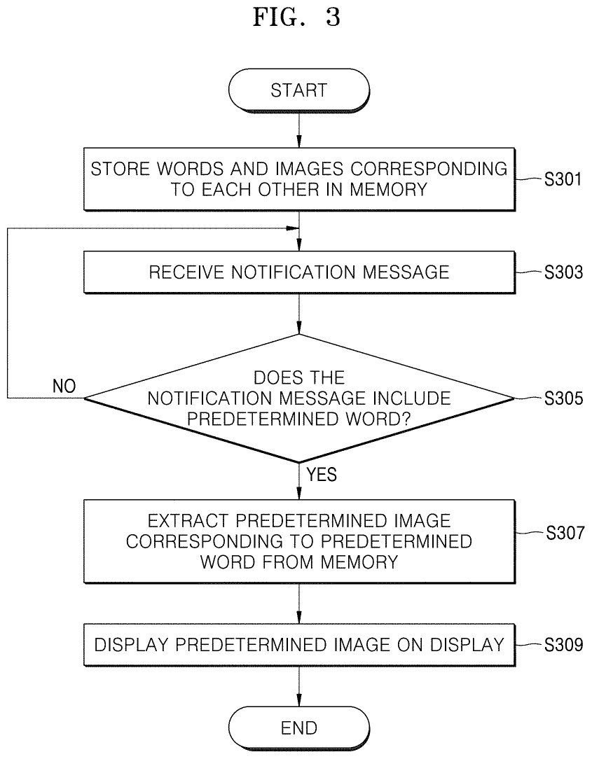

FIG. 3 is a flowchart of a disaster information providing method according to an embodiment of the disclosure.

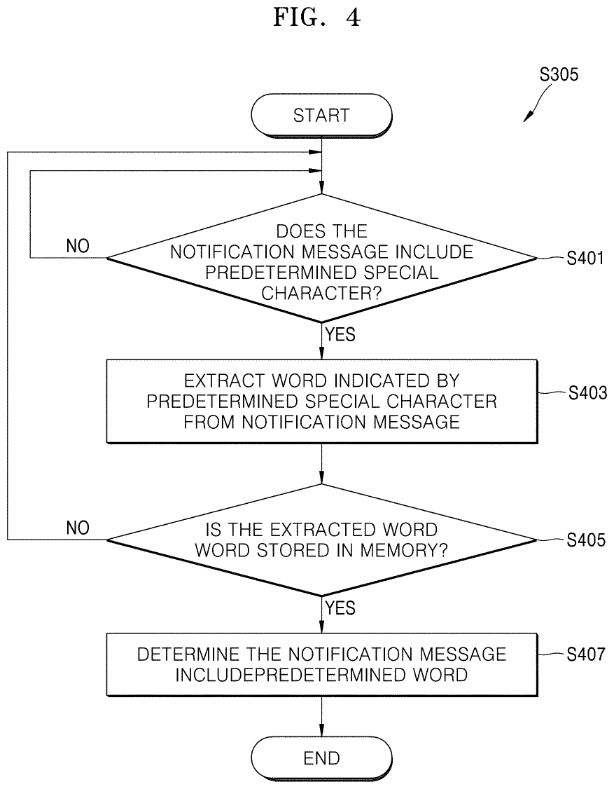

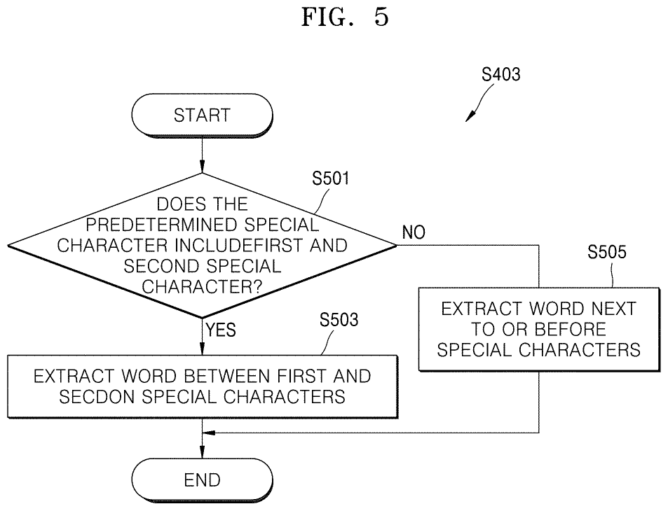

FIGS. 4 and 5 are flowcharts of a method of determining the inclusion of a predetermined word, according to an embodiment of the disclosure.

Referring to FIGS. 2 and 3, the disaster information providing apparatus 100 stores words and images corresponding to each other in the memory 150 (S301).

In this case, each of the words may include a language meaning a disaster type or action guidelines, and each of the images may include a non-language means indicating a disaster type or action guidelines.

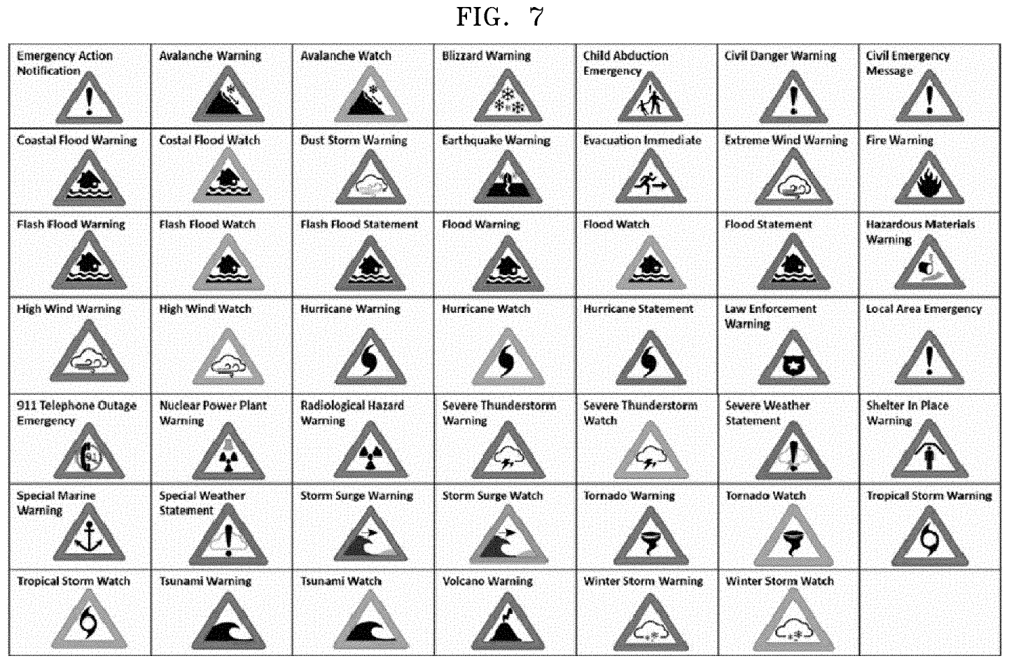

For example, the memory 150 may store, as illustrated in FIG. 7, words and still images matching each other. In this case, each of still images stored in the memory 150 may have a triangular shape having a predetermined width and a symbol signifying a disaster type is drawn inside the triangle.

FIG. 7 illustrates integrated public alert and warning system (IPAWS) symbols applicable to an embodiment of the disclosure. In the embodiments, variously shaped symbols other than the symbols illustrated in FIG. 7 may be matched with the words. FIG. 7 illustrates symbols in which a triangular border is displayed in a predetermined color indicating the emergency level of a disaster.

Next, when the communication interface 110 receives a notification message (S303), the processor 130 determines whether the notification message includes a predetermined word (S305).

For example, the predetermined word may be “Avalanche Warning”.

The notification message may be received through the SIB. The notification message may include, for example, an emergency disaster text message, an urgent disaster text message, and a safety guide text message.

Referring to FIG. 4, the processor 130 determines whether, for example, a notification message includes a predetermined special character (S401), and when the notification message includes the predetermined special character, extracts a word indicated by the predetermined special character from the notification message (S403).

Referring to FIG. 5, in this case, the processor 130 determines whether, for example, the predetermined special character includes a first special character and a second special character (S501), and when the predetermined special character includes the first special character and the second special character, extracts a word between the first special character and the second special character (S503).

The first special character may mean a special character indicating a start, and the second special character may mean a special character indicating an end.

The first special character and the second special character may include at least one different special character.

The first special character and the second special character may be different from each other in terms of the number of special characters included in each thereof.

When the predetermined special character does not include the first special character and the second special character, the processor 130 extracts a word after the predetermined special character or a word before the predetermined special character (S505).

The processor 130 may extract the predetermined word through operations S501 and S503, or operations S501 and S505, and the predetermined word through operations S503 or S505, but the disclosure is not limited thereto.

Next, referring to FIG. 4 again, the processor 130 determines whether the extracted word is the word stored in the memory 150 (S405), and when the extracted word is the word stored in the memory 150, determines that the notification message includes the predetermined word (S407).

Next, referring to FIG. 3 again, when the notification message includes the predetermined word, the processor 130 extracts an predetermined image corresponding to the predetermined word from the memory 150 (S307).

For example, when the notification message includes “Avalanche Warning”, the processor 130 may extract, from the memory 150, a still image in which a symbol expressing avalanche corresponding to the “Avalanche Warning” of FIG. 7 is drawn by using a slope, an arrow, and snow inside a triangular border having a predetermined width.

Next, the display 190 may display a predetermined image on a screen (S309).

The predetermined image may be displayed with a notification message, separately from the notification message, and in replacement of the notification message, but the disclosure is not limited thereto.

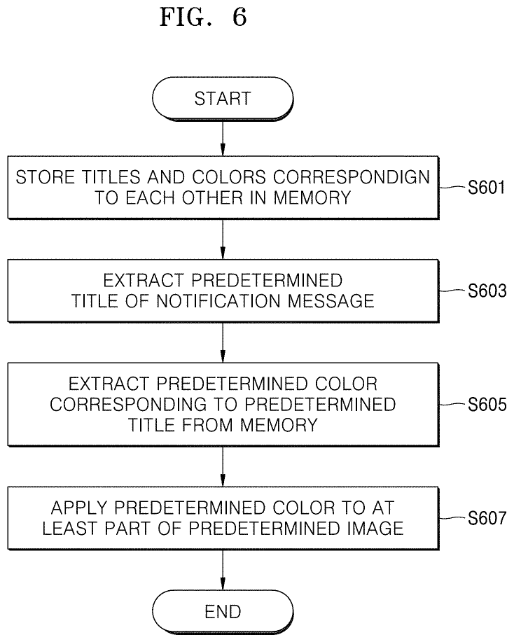

Next, a method of determining a color of a predetermined image displayed on a screen is described in detail with reference to FIG. 6. It is assumed with respect to FIG. 6 that the triangular borders of the symbols stored in the memory 150 are not displayed in a predetermined color, but the disclosure is not limited thereto.

FIG, 6 is a flowchart of a disaster information providing method according to an embodiment of the disclosure.

Referring to FIGS. 2 and 6, the disaster information providing apparatus 100 stores titles and colors corresponding to each other in the memory 150 (S301).

For example, the memory 150 may store “emergency disaster text” and “red”, “urgent disaster text” and “orange”, and “safety guide text” and “blue”, which correspond to each other.

Next, the processor 130 extracts a predetermined title of a notification message (S603), and a predetermined color corresponding to the predetermined title from the memory 150 (S605).

For example, the processor 130 may extract “emergency disaster text” corresponding to the title from the notification message, and “red” corresponding to “emergency disaster text” from the memory 150.

Next, the processor 130 applies the predetermined color to at least a part of a predetermined image (S607).

The processor 130 may apply the predetermined color to the predetermined image displayed on the screen as in operation S309. For example, the processor 130 may apply red to the inside of the triangular board having a predetermined width, which corresponds to “Avalanche Warning” of FIG. 7. Although it is not illustrated, the processor 130 may apply red to the background of the predetermined image, but the disclosure is not limited thereto.

According to embodiments, when a notification message including a letter expressed in a specific language is transmitted, by informing users of the meaning indicated by the notification message through a predetermined image and/or a predetermined color other than the specific language, the users may more intuitively detect and respond to danger through the above method.

According to embodiments, as intuitively understandable disaster information is provided to users with terminals having limited understandable languages, safety of terminal users may be improved.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A disaster information providing apparatus comprising:
a memory that stores words and images corresponding to each other;
a communication interface configured to receive a notification message;
a processor configured to determine whether the notification message includes a predetermined word, and when the notification message includes the predetermined word, extract a predetermined image corresponding to the predetermined word from the memory; and
a display that displays the predetermined image.

2. The disaster information providing apparatus of claim 1, wherein
each of the words includes a language meaning a disaster type or action guidelines,
each of the images includes a non-language means indicating a disaster type or action guidelines, and
each of the images includes a still image or a video.

3. The disaster information providing apparatus of claim 1, wherein the processor is further configured to determine whether the notification message includes a predetermined special character, extract a word indicated by the predetermined special character from the notification message when the notification message includes the predetermined special character, determine whether the extracted word is a word stored in the memory, and determine that the notification message includes the predetermined word when the extracted word is a word stored in the memory.

4. The disaster information providing apparatus of claim 3, wherein, to extract a word indicated by the predetermined special character from the notification message, the processor is further configured to extract a word between a first special character indicating a start and a second special character indicating an end.

5. A disaster information providing method comprising:
storing, by a memory, words and images corresponding to each other;
receiving, by a communication interface, a notification message;
determining, by a processor, whether the notification message includes a predetermined word;
when the notification message includes the predetermined word, extracting, by the processor, a predetermined image corresponding to the predetermined word from the memory; and
displaying, by a display, the predetermined image.
